(19) United States
(12) Patent Application Publication
(10) Pub. No.: US 2024/0120457 A1
(43) Pub. Date: Apr. 11, 2024

(54) FUNCTIONALLY GRADED AND SELECTIVE DEPOSITION OF ELECTRODE MATERIAL ON CURRENT COLLECTOR IN LI-ION BATTERY

(71) Applicant: Baker Hughes Oilfield Operations LLC, Houston, TX (US)

(72) Inventor: Navin Sakthivel, Spring, TX (US)

(21) Appl. No.: 17/961,652

(22) Filed: Oct. 7, 2022

(51) Int. Cl. H01M 4/04; B01F 23/50; B01F 23/53; B01F 27/724; B01F 35/71; B05D 1/26; G05D 11/13; H01M 4/1391; H01M 4/1393; H01M 4/1395; H01M 4/1397

(52) U.S. Cl. CPC H01M 4/0404; B01F 23/511; B01F 23/53; B01F 27/724; B01F 35/718051; B05D 1/26; G05D 11/13; H01M 4/1391; H01M 4/1393; H01M 4/1395; H01M 4/1397; H01M 2004/028

(57) ABSTRACT

A process of manufacturing an electrode includes: adding an electrode active material and an additive to a mixer to form an electrode composition, the additive comprising at least one of a binder or a conductive agent; depositing the electrode composition on a substrate to form a first electrode layer; varying the electrode composition by changing a relative amount of the electrode active material and the additive added to the mixer, changing a composition of the electrode active material added to the mixer, changing a composition of the additive added to the mixer, or a combination thereof to form a plurality of additional adjusted electrode compositions; depositing the plurality of the additional adjusted electrode compositions on the first electrode layer to additively form the electrode such that a concentration of the electrode active material, a concentration of the additive, the composition of the electrode active material, the composition of the additive, or a combination thereof vary from the substrate to an exposed surface of the electrode.

### BACKGROUND

Electrodes are typically manufactured by roll-to-roll manufacturing techniques. A roll-to-roll process can include homogenizing the electrode constituents and a solvent, which typically is water, in an extruder to form an electrode slurry, coating the electrode slurry on a metal foil, removing the solvent, and pressing down the coating to the desired thickness thereby making the electrode. However, electrodes manufactured from the process can have low current density due to the low wettability of the aqueous electrode slurry on the metal foil, undesirable heat generated during the process, and intra-layer lithium ion diffusion that may occur during the process. Accordingly, there is a continuing need for an improved method for manufacturing electrodes.

### SUMMARY

A process of manufacturing an electrode includes: adding an electrode active material and an additive to a mixer to form an electrode composition, the additive comprising at least one of a binder or a conductive agent; depositing the electrode composition on a substrate to form a first electrode layer; varying the electrode composition by changing a relative amount of the electrode active material and the additive added to the mixer, changing a composition of the electrode active material added to the mixer, changing a composition of the additive added to the mixer, or a combination thereof to form a plurality of additional adjusted electrode compositions; depositing the plurality of the additional adjusted electrode compositions on the first electrode layer to additively form the electrode such that a concentration of the electrode active material, a concentration of the additive, the composition of the electrode active material, the composition of the additive, or a combination thereof vary from the substrate to an exposed surface of the electrode.

### BRIEF DESCRIPTION OF THE DRAWINGS

The following descriptions should not be considered limiting in any way. With reference to the accompanying drawings, like elements are numbered alike:

FIG. 1 is a cross-sectional view of a portion of an electrode having functionally graded properties; and

FIG. 2 depicts an embodiment of a manufacturing system for additively forming an electrode.

### DETAILED DESCRIPTION

A detailed description of one or more embodiments of the disclosed method and system presented herein by way of exemplification and not limitation with reference to the Figures.

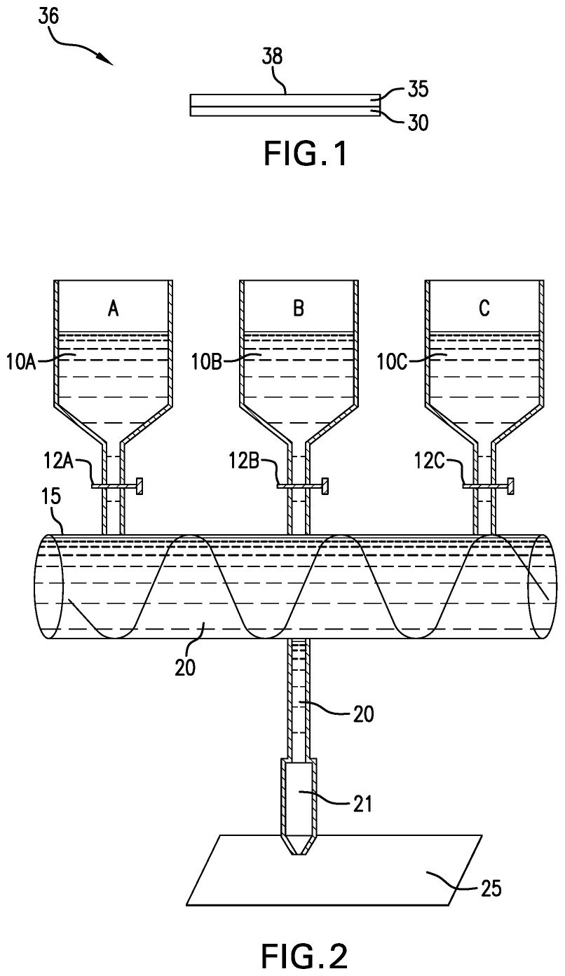

A process of additively manufacturing an electrode is described. The term additive manufacturing as used herein involves depositing or building an electrode layer-by-layer. The process is capable of producing a functionally graded electrode for lithium-ion batteries. Referring to FIG. 1, the manufactured electrode 36 includes a current collector 30 and an electrode active material layer 35 disposed on the current collector 30 wherein the electrode active material layer 35 comprises an electrode active material and an additive comprising at least one of a binder or a conductive agent. As used herein, the electrode active material layer 35 can include a plurality of sublayers.

By using an additive manufacturing process as described herein, the manufactured electrode 36 can have a variation of at least one of a concentration of the electrode active material, a concentration of the additive, the composition of the electrode active material, or the composition of the additive, from the current collector 30 to an exposed surface 38 of the electrode 36 or the electrode active material layer 35.

The process can be carried out in an additive manufacturing system as shown in FIG. 2. In use, an electrode active material A, and an additive comprising at least one of a binder B or a conductive agent C in hoppers 10A, 10B, and 10C respectively are added to a mixer 15, where the electrode active material and the additive are mixed to form an electrode composition 20. The mixer 15 can be a screw conveyor mixer. The electrode composition 20 is then deposited on a substrate 25, for example, a current collector, via a nozzle 21 forming a first electrode layer. In an aspect, forming the first electrode layer further comprises subjecting a deposit of the electrode composition to a temperature of about 25° C. to about 800° C. and a pressure of about 100 psi to about 1000 psi, preferably a temperature of about 50° C. to about 500° C. and a pressure of about 100 psi to about 500 psi.

To form a functionally graded electrode, the electrode composition can be varied by changing a relative amount of the electrode active material and the additive added to the mixer, changing a composition of the electrode active material added to the mixer, changing a composition of the additive added to the mixer, or a combination thereof to form a plurality of additional adjusted electrode compositions, then depositing the plurality of the additional adjusted electrode compositions on the first electrode layer, to additively form the electrode.

As used herein, changing the composition of the additive includes changing the material of at least one component of the additive. For example, changing a composition of the additive can include changing the material for the binder, changing the material for the conductive agent, or a combination thereof. If the additive comprises additional components, the materials for the additional components can be varied as well.

In a lithium-ion battery, electrochemical reactions occur at the electrode surface. Spontaneous reactions are desired as spontaneous reactions occur without being driven by an outside force, and nonspontaneous reactions require an energy input to proceed. In thermodynamics, Gibbs free energy change is the indicator that a reaction will be spontaneous. Thus reducing Gibbs free energy is necessary for a reaction to be spontaneous. Without wishing to be bound by theory, it is believed that by varying the concentrations of the electrode active material and/or the additive, by varying the materials of the electrode active material and/or the additive, or a combination thereof, Gibbs free energy change can be minimized, thus maximizing electrochemical potential.

As shown in FIG. 2, the electrode active material A and the additive comprising binder B and/or conductive agent C can be separately added to the mixer 15. Changing the relative amounts of the electrode active material and the additive added to the mixer can be achieved by controlling an amount of the electrode active material, an amount of the additive, or a combination thereof, added to the mixer using at least one of the flow regulating globe valves 12A, 12B, and 12C. The flow regulating globe valves are electronically coupled to a processor and are configured to control flow rates of the electrode active material, the binder, and the conductive agent.

“Plurality” as used in the context of additive manufacturing includes 2 or more layers. The maximum number of layers can vary greatly, determined, for example, by considerations such as the size of the electrode being manufactured, the technique used, the capabilities of the equipment used, and the level of detail desired in the final electrode. For example, 2 to 10 layers can be formed, or 2 to 5 layers can be formed. The thickness of each layer can vary. The thickness of each layer as formed can differ from a previous or subsequent layer. Alternatively, the thickness of each layer is the same. In an aspect, the thickness of each layer as formed is about 1 μm to about 30 μm or about 0.001 mm to about 0.03 mm. A total thickness of the electrode can vary from about 5 microns to about 100 microns, or about 5 microns to about 60 microns.

Advantageously, the process is a continuous process. In the process, the electrode active material A, the binder B, and the conductive agent C are continuously and separately added to the screw conveyor mixer 15, each via a flow regulating globe valve 12A, 12B or 12C. The electrode active material A, the binder B, and the conductive agent C are mixed in the screw conveyor mixer 15 to form the electrode composition 20, which is continuously deposited on a current collector 25 to additively form the electrode.

The electrode composition can comprise additional components such as a solvent, a surfactant, and the like. In an aspect, the electrode composition comprises less than about 5 wt %, less than about 30 wt % or about less than 50 wt % of solvents such as water or an organic solvent, based on a total weight of the electrode composition. Preferably, no solvents are added to the mixer, and the electrode composition can be free of solvents.

The process can be used to manufacture a cathode. In such an instance, the electrode composition is a cathode composition comprising a cathode active material as the electrode active material, and an additive comprising at least one of a binder or a conductive agent.

The cathode active material is not particularly limited. Preferably, the cathode active material comprises at least one of lithium manganese oxide (LMO), lithium nickel manganese oxide (LNMO), lithium nickel cobalt manganese oxide (NMC), lithium nickel cobalt aluminum oxide (NCA), lithium nickel cobalt oxide (LCO), lithium iron phosphate (LFP), or lithium manganese iron phosphate (LMFP). Other suitable cathode active material known in the art can also be used.

Representative binders include polyvinylidene difluoride, polyvinyl alcohol, carboxymethyl cellulose, starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, or a copolymer thereof. A combination comprising at least one of the foregoing may be used. Other suitable binders known in the art can also be used.

Representative conductive agents include ketjen black, carbon black, graphite, carbon nanotubes, carbon fiber, mesoporous carbon, mesocarbon microbeads, oil furnace black, extra-conductive black, acetylene black, or lamp black. A combination comprising at least one of the foregoing may be used. Other suitable conductive agents known in the art can also be used.

The cathode may comprise a current collector. The current collector for the cathode may comprise aluminum.

The process as described herein can be used to manufacture an anode. In such an instance, the electrode composition is an anode composition comprising an anode active material as the electrode active material, and an additive comprising at least one of a binder or a conductive agent.

Examples of the anode active material include graphite, hard carbon, and silicon. Other suitable anode active material known in the art can also be used. A combination comprising at least one of the anode active material can be used. The binder and the conductive agent for the anode composition may be the same as the binder and the conductive agent as described herein for the cathode composition.

The anode may comprise a current collector. The current collector for the anode may comprise copper.

Set forth below are some aspects of the foregoing disclosure:

Aspect 1. A process of manufacturing an electrode, the process comprising: adding an electrode active material and an additive to a mixer to form an electrode composition, the additive comprising at least one of a binder or a conductive agent; depositing the electrode composition on a substrate to form a first electrode layer; varying the electrode composition by changing a relative amount of the electrode active material and the additive added to the mixer, changing a composition of the electrode active material added to the mixer, changing a composition of the additive added to the mixer, or a combination thereof to form a plurality of additional adjusted electrode compositions; depositing the plurality of the additional adjusted electrode compositions on the first electrode layer to additively form the electrode such that a concentration of the electrode active material, a concentration of the additive, the composition of the electrode active material, the composition of the additive, or a combination thereof vary from the substrate to an exposed surface of the electrode.

Aspect 2. The process as in any prior aspect, wherein the electrode active material and the additive are separately added to the mixer, and changing the relative amounts of the electrode active material and the additive added to the mixer comprise controlling an amount of the electrode active material, an amount of the additive, or a combination thereof, added to the mixer using a flow regulating globe valve.

Aspect 3. The process as in any prior aspect, wherein the flow regulating globe valve is electrically controlled.

Aspect 4. The process as in any prior aspect, wherein the additive comprises the binder and the conductive agent; and the binder and the conductive agent are separately added to the mixer, each via a flow regulating globe valve.

Aspect 5. The process as in any prior aspect, wherein the mixer is a screw conveyor mixer.

Aspect 6. The process as in any prior aspect, wherein forming the first electrode layer further comprises subjecting a deposit of the electrolyte composition to a temperature of about 25 to about 800° C. and a pressure of about 100 to about 1,000 psi.

Aspect 7. The process as in any prior aspect, wherein the substrate is a current collector.

Aspect 8. The process as in any prior aspect, wherein the electrode is a cathode, and the electrode active material is a cathode active material.

Aspect 9. The process as in any prior aspect, wherein the cathode active material comprises at least one of lithium manganese oxide, lithium nickel manganese oxide, lithium nickel cobalt manganese oxide, lithium nickel cobalt aluminum oxide, lithium nickel cobalt oxide, lithium iron phosphate, or lithium manganese iron phosphate.

Aspect 10. The process as in any prior aspect, wherein the electrode is an anode, and the active electrode material is an anode active material.

Aspect 11. The process as in any prior aspect, wherein the anode active material comprises at least one of graphite, hard carbon, or silicon.

Aspect 12. The process of as in any prior aspect, wherein the electrode composition comprises less than 30 weight percent of solvents.

Aspect 13. The process as in any prior aspect, wherein the electrode composition is free of solvents.

Aspect 14. The process as in any prior aspect, wherein the first electrode active material layer has a thickness of about 1 micron to about 30 microns.

Aspect 15. The process as in any prior aspect, wherein the process is a continuous process.

Aspect 16. The process as in any prior aspect, wherein the process comprises continuously and separately adding the electrode active material, the binder, and the conductive agent, each via a flow regulating globe valve, to a screw conveyor mixer, the flow regulating glove valve being electrically coupled to a processor and configured to independently control a flow rate of the electrode active material, the binder, and the conductive agent; mixing the electrode active material, the binder, and the conductive agent in the screw conveyor mixture to form the electrode composition; and continuously depositing the electrode composition on the substrate, which is a current collector to additively form the electrode such that a concentration of the electrode active material, a concentration of the binder, a concentration of the conductive agent, the composition of the electrode active material, the composition of the binder, the composition of the conductive agent, or a combination thereof vary from the substrate to an exposed surface of the electrode.

All ranges disclosed herein are inclusive of the endpoints, and the endpoints are independently combinable with each other. As used herein, “combination” is inclusive of blends, mixtures, alloys, reaction products, and the like. All references are incorporated herein by reference in their entirety.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” The modifier “about” used in connection with a quantity is inclusive of the stated value and has the meaning dictated by the context (e.g., it includes the degree of error associated with measurement of the particular quantity).

Amendment to the claims:

1. A process of manufacturing an electrode, the process comprising:
separately adding an electrode active material and an additive to a mixer to form an electrode composition, the additive comprising at least one of a binder or a conductive agent;
depositing the electrode composition on a substrate to form a first electrode layer;
varying the electrode composition by changing a relative amount of the electrode active material and the additive added to the mixer, and optionally by further changing a composition of the electrode active material added to the mixer, changing a composition of the additive added to the mixer, or a combination thereof to form a plurality of additional adjusted electrode compositions;
depositing the plurality of the additional adjusted electrode compositions on the first electrode layer to additively form the electrode such that a concentration of the electrode active material, a concentration of the additive, the composition of the electrode active material, the composition of the additive, or a combination thereof vary from the substrate to an exposed surface of the electrode,
wherein the electrode composition is free of solvents, and
wherein changing the relative amounts of the electrode active material and the additive added to the mixer comprises controlling an amount of the electrode active material, an amount of the additive, or a combination thereof, added to the mixer using a flow regulating globe valve.

2. (canceled)

3. The process of claim 1, wherein the flow regulating globe valve is electrically controlled.

4. The process of claim 1, wherein the additive comprises the binder and the conductive agent; and the binder and the conductive agent are separately added to the mixer, each via a flow regulating globe valve.

5. The process of claim 1, wherein the mixer is a screw conveyor mixer.

6. The process of claim 1, wherein forming the first electrode layer further comprises subjecting a deposit of the electrode composition to a temperature of about 25 to about 800° C. and a pressure of about 100 to about 1,000 psi.

7. The process of claim 1, wherein the substrate is a current collector.

8. The process of claim 1, wherein the electrode is a cathode, and the electrode active material is a cathode active material.

9. The process of claim 8, wherein the cathode active material comprises at least one of lithium manganese oxide, lithium nickel manganese oxide, lithium nickel cobalt manganese oxide, lithium nickel cobalt aluminum oxide, lithium nickel cobalt oxide, lithium iron phosphate, or lithium manganese iron phosphate.

10. The process of claim 1, wherein the electrode is an anode, and the active electrode material is an anode active material.

11. The process of claim 10, wherein the anode active material comprises at least one of graphite, carbon, or silicon.

12. (canceled)

13. (canceled)

14. The process of claim 1, wherein the first electrode active material layer has a thickness of about 1 micron to about 30 microns.

15. The process of claim 1, wherein the process is a continuous process.

16. The process of claim 15, wherein the process comprises
continuously and separately adding the electrode active material, the binder, and the conductive agent, each via a flow regulating globe valve, directly to a screw conveyor mixer, the flow regulating globe valve being electrically coupled to a processor and configured to independently control a flow rate of the electrode active material, the binder, and the conductive agent;
mixing the electrode active material, the binder, and the conductive agent in the screw conveyor mixture to form the electrode composition; and
continuously depositing the electrode composition on the substrate, which is a current collector to additively form the electrode such that a concentration of the electrode active material, a concentration of the binder, a concentration of the conductive agent, the composition of the electrode active material, the composition of the binder, the composition of the conductive agent, or a combination thereof vary from the substrate to an exposed surface of the electrode.
